(19) United States
(12) Patent Application Publication
(10) Pub. No.: US 2021/0097104 A1
(43) Pub. Date: Apr. 1, 2021

(54) PAINTING LABEL GENERATION METHOD AND ELECTRONIC DEVICE

(71) Applicant: BOE TECHNOLOGY GROUP CO., LTD., Beijing (CN)

(72) Inventors: Xibo ZHOU, Beijing (CN); Hui LI, Beijing (CN)

(21) Appl. No.: 16/935,558

(22) Filed: Jul. 22, 2020

(30) Foreign Application Priority Data
Sep. 27, 2019 (CN) 201910925106.5

(51) Int. Cl. G06F 16/58; G06F 16/55; G06F 40/242; G06F 40/44

(52) U.S. Cl. CPC G06F 16/5866; G06F 40/44; G06F 40/242; G06F 16/55

(57) ABSTRACT

The present disclosure provides a painting label generation method and an electronic device. The method includes: obtaining painting basic information and painting brief introduction information of a target painting; generating painting attribute information by pre-processing the painting basic information; generating a painting theme word by extracting a theme word from the painting brief introduction information; and generating a painting label for the target painting according to the painting attribute information and the painting theme word.

### CROSS-REFERENCE TO RELATED APPLICATION

This application claims the benefit and priority of Chinese Application No. 201910925106.5, filed on Sep. 27, 2019, which is incorporated herein by reference in its entirety.

### TECHNICAL FIELD

The present disclosure relates to the field of image processing technologies, and in particular to a painting label generation method and an electronic device.

### BACKGROUND

Resources of paintings are becoming increasingly abundant. When a user wants to search for a painting, the user may not be able to accurately indicate the name of the painting, but input information such as an author of the painting, genre, and even the content of the painting. In addition, when recommending paintings of interest to users, it is also necessary to construct a complete labeling system for painting resources. However, current attribute information of online painting resources is missing or content thereof is not standardized. Further, an introduction of content of the painting is usually a descriptive paragraph, lacking a content label.

### SUMMARY

One embodiment of the present disclosure provides a painting label generation method, including: obtaining painting basic information and painting brief introduction information of a target painting; generating painting attribute information by pre-processing the painting basic information; generating a painting theme word by extracting a theme word from the painting brief introduction information; and generating a painting label for the target painting according to the painting attribute information and the painting theme word.

Optionally, the generating a painting theme word by extracting a theme word from the painting brief introduction information, includes: performing word segmentation processing on the painting brief introduction information to obtain a plurality of introduction-word segmentations; inputting the plurality of introduction-word segmentations to a preset theme generation model, and obtaining the painting theme word.

Optionally, the performing word segmentation processing on the painting brief introduction information to obtain a plurality of introduction-word segmentations, includes: constructing a prefix dictionary based on a dictionary of a corpus, and counting occurrence frequencies of prefix words of the prefix dictionary in the dictionary of the corpus; based on the prefix dictionary, obtaining a plurality of text segmentation modes for each sentence of information text in the painting brief introduction information; determining a segmentation probability of each of the plurality of text segmentation modes in combination with each sentence of information text and each of the occurrence frequencies; obtaining the text segmentation mode with a maximum segmentation probability among the plurality of text segmentation modes; using the text segmentation mode with the maximum segmentation probability to perform word segmentation processing on the painting brief introduction information, thereby obtaining the plurality of introduction-word segmentations.

Optionally, the performing word segmentation processing on the painting brief introduction information to obtain a plurality of introduction-word segmentations, includes: constructing a hidden Markov model (HMM) based on to-be-segmented texts in the painting brief introduction information; obtaining a plurality of word segmentation sequences corresponding to the to-be-segmented texts; inputting the plurality of word segmentation sequences to the hidden Markov model; receiving a probability of each of the plurality of word segmentation sequences output by the hidden Markov model; selecting one word segmentation sequence with a maximum probability from the plurality of word segmentation sequences, for performing word segmentation processing on the painting brief introduction information, thereby obtaining the plurality of introduction-word segmentations.

Optionally, the inputting the plurality of introduction-word segmentations to a preset theme generation model, and obtaining the painting theme word, includes: determining the number of themes, a first hyperparameter and a second hyperparameter; according to the number of themes, randomly assigning a theme index to each of the plurality of introduction-word segmentations; calculating a theme distribution probability of the painting brief introduction information based on the first hyperparameter; calculating a theme word distribution probability of each of the plurality of introduction-word segmentations based on the second hyperparameter; updating the theme index of each of the plurality of introduction-word segmentations with Gibbs sampling formula, and repeatedly performing the step of calculating a theme distribution probability of the painting brief introduction information based on the first hyperparameter and the step of calculating a theme word distribution probability of each of the plurality of introduction-word segmentations based on the second hyperparameter; when reaching convergence condition, calculating a synthetic index distribution probability for each theme index based on calculated theme distribution probabilities and theme word distribution probabilities; calculating a synthetic word distribution probability of each theme word based on the synthetic index distribution probability of each theme index; using the theme word corresponding to a maximum synthetic word distribution probability selected from the synthetic word distribution probability of each theme word as the painting theme word.

Optionally, before the generating a painting label for the target painting according to the painting attribute information and the painting theme word, the method further includes: performing clustering processing on the painting theme word to obtain a theme word category corresponding to the painting theme word. The generating a painting label for the target painting according to the painting attribute information and the painting theme word, includes: generating the painting label based on the painting attribute information and the theme word category.

Optionally, the performing clustering processing on the painting theme word to obtain a theme word category corresponding to the painting theme word, includes: performing word embedding-encoding processing on the painting theme word to generate a theme word vector corresponding to the painting theme word; performing clustering processing on the painting theme word according to the theme word vector, to generate the theme word category.

Optionally, the performing word embedding-encoding processing on the painting theme word to generate a theme word vector corresponding to the painting theme word, includes: inputting the painting theme word into a word vector model; receiving the theme word vector output by the word vector model.

Optionally, the performing word embedding-encoding processing on the painting theme word to generate a theme word vector corresponding to the painting theme word, includes: constructing an initial clustering feature tree according to the theme word vector; determining the theme word category corresponding to the theme word vector based on the initial clustering feature tree and a maximum radius threshold.

Optionally, the painting basic information includes at least one of author information, size information, creation year information and price information. The generating painting attribute information by pre-processing the painting basic information, includes at least one of: adjusting the author information according to a preset name format to generate a painting name attribute; determining a size proportion attribute corresponding to the target painting according to the size information; determining a year classification attribute corresponding to the target painting according to the creation year information; determining a price classification attribute corresponding to the target painting according to the price information.

One embodiment of the present disclosure provides an electronic device, including: a processor, a memory, and a computer program stored on the memory and executable on the processor; wherein the processor executes the program to implement steps of: obtaining painting basic information and painting brief introduction information of a target painting; generating painting attribute information by pre-processing the painting basic information; generating a painting theme word by extracting a theme word from the painting brief introduction information; and generating a painting label for the target painting according to the painting attribute information and the painting theme word.

### BRIEF DESCRIPTION OF THE DRAWINGS

FIG. 1 is a flowchart of a painting label generation method according to an embodiment of the present disclosure; and

FIG. 2 is a flowchart of a painting label generation method according to an embodiment of the present disclosure.

### DETAILED DESCRIPTION

In order to make the objects, features and the advantages of the present disclosure more apparent, the present disclosure will be described hereinafter in a clear and complete manner in conjunction with the drawings and embodiments.

Painting labels in related art are usually manually added, which is likely to cause inconsistent labeling, typos, etc. Further, manual addition of painting labels has a large workload, which will consume more human resource costs.

In view of this, embodiments of the present disclosure provide a painting label generation method and an electronic device, which can solve the problems in the related art that manual addition of painting labels is likely to cause inconsistent labeling, typos and has a large workload, which will consume more human resource costs.

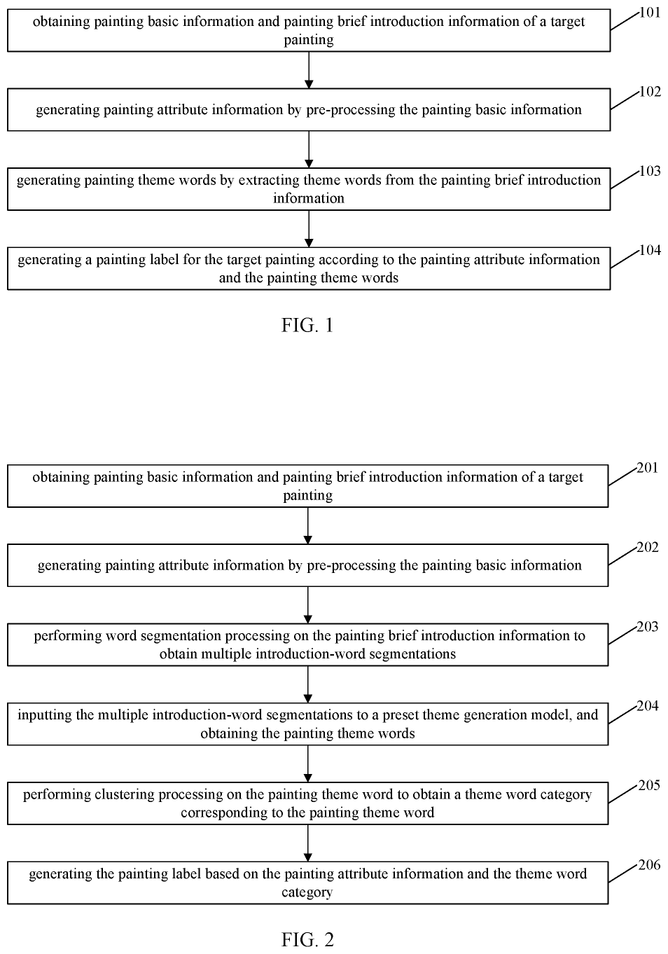

Referring to FIG. 1, FIG. 1 is a flowchart of a painting label generation method according to an embodiment of the present disclosure. The painting label generation method may specifically include the following steps.

Step 101: obtaining painting basic information and painting brief introduction information of a target painting.

In one embodiment of the present disclosure, the target painting refers to calligraphy and painting for which a user adds a label, for example, the paintings of Picasso used for adding labels, or the paintings of Da Vinci used for adding labels, etc.

In some examples, the target painting may be obtained by searching from the internet according to an author's name, for example, entering “Picasso” in a search engine to obtain Picasso's painting as the target painting.

In some examples, a camera device may be used to capture a painting to get the target painting. For example, when a user sees a painting that needs to be labeled in an exhibition, the user captures the painting through a camera of a mobile phone, thereby obtaining the target painting.

It will be appreciated that the above examples are only examples for better understanding of the technical solutions of the embodiments of the present disclosure, and are not intended to be limited as the only embodiment of the present disclosure.

In specific implementation, the target painting may also be obtained in other ways, which may be determined according to service requirements and is not limited in the embodiment of the present disclosure.

The painting basic information refers to basic description information of the target painting. The painting basic information may include basic description information of the painting, such as painting name, painting author, nationality, creation year, creation place, creation medium, size, genre, collection place, category, and price.

The painting name refers to a name given to the painting, such as “Savior”, “Avignon Girl”.

The painting author refers to a name of an author of the target painting. For example, the author of “Savior” is Leonardo da Vinci and the author of “Girl of Avignon” is Picasso.

The nationality refers to the nationality of the author of the painting. For example, Da Vinci's nationality is Italian.

The creation year refers to a year in which the target painting was created, such as created in 1990 or 1985.

The creation place refers to a place where the target painting is created, such as Beijing, China, California USA.

The creative medium refers to a medium for creating the target painting, such as rice paper, cloth.

The size refers to a length and a width of the target painting.

The genre refers to a genre to which the target painting belongs.

The collection place refers to a collection place of the target painting, such as the Beijing Museum of China.

The category refers to a category of the target painting, such as landscape, animals.

The price refers to a current price of the target painting, such as 20 W, or 5.5 W.

It will be appreciated that the above examples of the painting basic information are only for the purpose of better understanding the technical solutions of the embodiments of the present disclosure, and are not intended to be limited as the only embodiment of the present disclosure.

The painting name, the painting author, the creation medium, the genre, the collection place are specialized vocabulary in the art field. The painting brief introduction information is a long text.

The painting brief introduction information refers to brief introduction information of the target painting, for example, some introduction information of the famous painting “Savior”.

In some examples, the painting basic information and the painting brief introduction information of the target painting may be obtained from a designated painting database.

In some examples, the painting basic information and the painting brief introduction information of the target painting may be obtained from the internet via a search engine.

After the painting basic information and the painting brief introduction information of the target painting are obtained, steps 102 and 103 are performed.

Step 102: generating painting attribute information by pre-processing the painting basic information.

The painting attribute information refers to attribute information that describes the target painting, such as painting name attribute, size ratio attribute, category attribute.

After obtaining the painting basic information of the target painting, there are various inconsistencies in author information, such as punctuation default, aliases, simplified and traditional Chinese, and thus it is needed to pre-process the painting basic information, thereby obtaining the painting attribute information of the target painting.

The painting attribute information of the target painting can be generated through the process of pre-processing the painting basic information of the target painting.

Step 103: generating painting theme words by extracting theme words from the painting brief introduction information.

The painting theme words refer to theme words extracted from the painting brief introduction information. After the painting brief introduction information is obtained, the painting brief introduction information may be segmented to obtain multiple word segmentations, and then the obtained word segmentations may be input into a theme generation model. A theme word corresponding to each word segmentation is output by the theme generation model, thereby obtaining the painting theme words.

It will be appreciated that, after extracting theme words from the painting brief introduction information corresponding to one target painting, multiple painting theme words may be obtained.

A detailed process of generating painting theme words will be described hereinafter in the following embodiments.

After the painting theme words are obtained according to the painting brief introduction information and the painting attribute information is obtained according to the painting basic information, step 104 is performed.

Step 104: generating a painting label for the target painting according to the painting attribute information and the painting theme words.

After obtaining the painting attribute information and theme words corresponding to the target painting, a painting label is generated for the target painting according to the painting attribute information and the painting theme words. Specifically, at least one category, i.e., theme word category, to which the painting theme words belong may be determined according to the painting theme words; and the painting attribute information and theme word category are used together as the painting label of the target painting.

The process of generating a painting label for the target painting according to the painting attribute information and the painting theme words will be described in detail in the following embodiments.

In one embodiment of the present disclosure, the painting label of the target painting is automatically generated according to the painting basic information and the painting brief introduction information, without manually adding the painting label.

In the painting label generation method according to one embodiment of the present disclosure, the painting basic information and the painting brief introduction information of the target painting is first obtained, and then the painting attribute information is generated by pre-processing the painting basic information; then, painting theme words are generated by extracting theme words from the painting brief introduction information and then a painting label is generated for the target painting according to the painting attribute information and the painting theme words. In this way, the painting label of the target painting is automatically generated according to the painting basic information and the painting brief introduction information, without manually adding the painting label, thereby ensuring consistency of painting labels, avoiding redundant label information, and reducing investment in human resources costs.

Referring to FIG. 2, FIG. 2 is a flowchart of a painting label generation method according to an embodiment of the present disclosure. The painting label generation method may specifically include the following steps.

Step 201: obtaining painting basic information and painting brief introduction information of a target painting.

In one embodiment of the present disclosure, the target painting refers to calligraphy and painting for which a user adds a label, for example, the paintings of Picasso used for adding labels, or the paintings of Da Vinci used for adding labels, etc.

In some examples, the target painting may be obtained by searching from the internet according to an author's name, for example, entering “Picasso” in a search engine to obtain Picasso's painting as the target painting.

In some examples, a camera device may be used to capture a painting to get the target painting. For example, when a user sees a painting that needs to be labeled in an exhibition, the user captures the painting through a camera of a mobile phone, thereby obtaining the target painting.

It will be appreciated that the above examples are only examples for better understanding of the technical solutions of the embodiments of the present disclosure, and are not intended to be limited as the only embodiment of the present disclosure.

In specific implementation, the target painting may also be obtained in other ways, which may be determined according to service requirements and is not limited in the embodiment of the present disclosure.

The painting basic information refers to basic description information of the target painting. The painting basic information may include basic description information of the painting, such as painting name, painting author, nationality, creation year, creation place, creation medium, size, genre, collection place, category, and price.

The painting name refers to a name given to the painting, such as “Savior”, “Avignon Girl”.

The painting author refers to a name of an author of the target painting. For example, the author of “Savior” is Leonardo da Vinci and the author of “Girl of Avignon” is Picasso.

The nationality refers to the nationality of the author of the painting. For example, Da Vinci's nationality is Italian.

The creation year refers to a year in which the target painting was created, such as created in 1990 or 1985.

The creation place refers to a place where the target painting is created, such as Beijing, China, California USA.

The creative medium refers to a medium for creating the target painting, such as rice paper, cloth.

The size refers to a length and a width of the target painting.

The genre refers to a genre to which the target painting belongs.

The collection place refers to a collection place of the target painting, such as the Beijing Museum of China.

The category refers to a category of the target painting, such as landscape, animals.

The price refers to a current price of the target painting, such as 20 W, or 5.5 W.

It will be appreciated that the above examples of the painting basic information are only for the purpose of better understanding the technical solutions of the embodiments of the present disclosure, and are not intended to be limited as the only embodiment of the present disclosure.

The painting name, the painting author, the creation medium, the genre, the collection place are specialized vocabulary in the art field. The painting brief introduction information is a long text.

The painting brief introduction information refers to brief introduction information of the target painting, for example, some introduction information of the famous painting “Savior”.

In some examples, the painting basic information and the painting brief introduction information of the target painting may be obtained from a designated painting database.

In some examples, the painting basic information and the painting brief introduction information of the target painting may be obtained from the internet via a search engine.

After the painting basic information and the painting brief introduction information of the target painting are obtained, steps 202 and 203 are performed.

Step 202: generating painting attribute information by pre-processing the painting basic information.

The painting attribute information refers to attribute information that describes the target painting, such as painting name attribute, size ratio attribute, category attribute.

After obtaining the painting basic information of the target painting, there are various inconsistencies in author information, such as punctuation default, aliases, simplified and traditional Chinese, and thus it is needed to pre-process the painting basic information, thereby obtaining the painting attribute information of the target painting.

The process of pre-processing the painting basic information may refer to the following description of the specific implementation manner.

In a specific implementation of one embodiment of the present disclosure, when the painting basic information includes at least one of author information, size information, creation year information and price information, the above step 202 may include:

Sub-step A1: adjusting the author information according to a preset name format to generate a painting name attribute.

In one embodiment of the present disclosure, when the painting basic information is the author information of the target painting, there may be various inconsistencies in the author information, such as punctuation defaults, aliases, simplified and traditional Chinese (for example, Vincent Van Gogh, other synonyms include Vincent Van Gogh, Van Gogh, etc.). A dictionary may be constructed based on author's introduction in Wiki/Baidu Encyclopedia, with a unified format setting for the author name format and correcting wrong writing.

In view of this situation, a specified name format, i.e., the preset name format, may be set in advance, and the author information of the target painting may be adjusted according to the preset name format, thereby generating the painting name attribute of the target painting.

Sub-step A2: determining a size proportion attribute corresponding to the target painting according to the size information.

When the painting basic information is the size information of the target painting, the painting size is generally composed of length and width (the unit is cm), and combinations of the values are too discrete. In one embodiment of the present disclosure, in order to classify the painting size, a size proportion of the target painting can be calculated according to the size information of the target painting, and is taken as the size proportion attribute of the target painting. For example, when a length of the target painting is 100 cm and a width of the target painting is 30 cm, the size proportion attribute of the target painting is 0.3, that is a ratio of width/length is 0.3.

It will be appreciated that the above examples are only examples for better understanding of the technical solutions of the embodiments of the present disclosure, and are not intended to be limited as the only embodiment of the present disclosure.

Sub-step A3: determining a year classification attribute corresponding to the target painting according to the creation year information.

The year classification attribute refers to an attribute for classifying the target painting according to the year.

When the painting basic information is the creation year information, in order to classify the target painting, the year classification attribute of the target painting may be determined according to the creation year information of the target painting. For example, when the creation year of the target painting is 1985, the year classification attribute of the target painting may be classified as 80 years.

Sub-step A4: determining a price classification attribute corresponding to the target painting according to the price information.

The price classification attribute refers to an attribute for classifying the target painting according to the price of the target painting.

When the painting basic information is the price information, in order to classify the target painting, the price classification attribute of the target painting may be determined according to the price information of the target painting. For example, the price of the target painting is 25,000 yuan, and the price classification attribute of the target painting may be classified as ten thousand yuan level.

It will be appreciated that the above examples are only examples for better understanding of the technical solutions of the embodiments of the present disclosure; when the painting basic information is other information, attribute setting conditions corresponding to the other information may be set in advance and then attributes of the target painting can be set, which may be determined according to service requirements and is not limited in the embodiment of the present disclosure.

Step 203: performing word segmentation processing on the painting brief introduction information to obtain multiple introduction-word segmentations.

The introduction-word segmentation refers to a word segmentation text obtained after performing word segmentation processing on the painting brief introduction information.

The painting brief introduction information is a long text, and the painting brief introduction information is needed to be processed by the natural language processing technology.

First, word segmentation is performed on the painting brief introduction information. A specific word segmentation method is described as follows.

In a specific implementation of the present disclosure, the above step 203 may include:

Sub-step M1: constructing a prefix dictionary based on a dictionary of a corpus, and counting occurrence frequencies of multiple prefix words of the prefix dictionary in the dictionary.

In one embodiment of the present disclosure, the corpus refers to a pre-formed corpus, such as Baidu corpus. A dictionary is preset in the corpus, and different sentence texts are recorded in the dictionary.

First, a prefix dictionary may be constructed based on a dictionary in the corpus. The prefix dictionary is a prefix dictionary associated with paintings. The prefix dictionary records prefix words associated with paintings, such as landscape painting and sketches.

Then, occurrence frequencies of multiple prefix words of the prefix dictionary in the dictionary are counted.

After counting occurrence frequencies of multiple prefix words of the prefix dictionary in the dictionary, sub-step M2 is performed.

Sub-step M2: based on the prefix dictionary, obtaining multiple text segmentation modes for each sentence of information text in the painting brief introduction information.

Based on the prefix dictionary constructed above, multiple text segmentation modes may be obtained for each sentence of information text in the painting brief introduction information, such as two-word segmentation, three-word segmentation, or mixed segmentation. Specifically, for each sentence of information text in the painting brief introduction information, a directed acyclic graph, which is composed of all possible words that may be formed by Chinese characters in each sentence, is generated according to the prefix dictionary, thereby obtaining all possible sentence segmentation forms.

After obtaining multiple text segmentation modes for each sentence of information text in the painting brief introduction information based on the prefix dictionary, sub-step M3 is performed.

Sub-step M3: determining a segmentation probability of each text segmentation mode in combination with each sentence of information text and each occurrence frequency.

For each text segmentation mode, an occurrence frequency of each segmented word in the prefix dictionary is first searched, and then a dynamic programming algorithm is used to calculate the maximum probability for each sentence in reverse from right to left, thereby obtaining the segmentation probability of each text segmentation mode.

After determining a segmentation probability of each text segmentation mode in combination with each sentence of information text and each occurrence frequency of each prefix word, sub-step M4 is performed.

Sub-step M4: obtaining the text segmentation mode with the maximum segmentation probability among the text segmentation modes.

Sub-step M5: using the text segmentation mode with the maximum segmentation probability to perform word segmentation processing on the painting brief introduction information, thereby obtaining multiple introduction-word segmentations.

After obtaining the segmentation probability of each text segmentation mode, the text segmentation mode with the maximum segmentation probability may be selected according to the various segmentation probabilities. Then, the text segmentation mode with the maximum segmentation probability, as the final segmentation mode, may be used to perform word segmentation processing on the painting brief introduction information, thereby obtaining multiple introduction-word segmentations.

In one embodiment of the present disclosure, a hidden Markov model (HMM) may be used to determine word segmentation mode, which will be described in detail with reference to the following specific implementation mode.

In a specific implementation mode of the present disclosure, the foregoing step 203 may include:

Sub-step N1: constructing a hidden Markov model based on to-be-segmented texts in the painting brief introduction information.

In one embodiment of the present disclosure, the Hidden Markov Model (HMM) is a statistical model that can be used to describe a Markov process with hidden unknown parameters. The difficulty is to determine the hidden parameters of the process from observable parameters. These parameters are then used for further analysis, such as mode recognition.

The to-be-segmented texts may be all texts in the painting brief introduction information, or may be text that does not exist in the dictionary after the above segmentation mode, which may be determined according to service requirements and is not limited herein.

After obtaining the to-be-segmented texts in the painting brief introduction information, a hidden Markov model may be constructed based on the to-be-segmented texts in the painting brief introduction information, and then sub-step N2 is performed.

Sub-step N2: obtaining multiple word segmentation sequences corresponding to the to-be-segmented texts.

The word segmentation sequence refers to a sequence formed by the to-be-segmented texts, i.e., a sentence observation sequence.

In the painting brief introduction information, painting content introduction text may be divided according to orders of words to obtain a variety of word segmentation sequences, and the result of the word segmentation is state sequences. In other words, the state of each word includes B (Begin), E (End), M (Middle) and S (Single), thereby obtaining four state sequences including B, E, M and S for each sentence of information text.

Sub-step N3: inputting the multiple word segmentation sequences to the hidden Markov model.

Sub-step N4: receiving a probability of each word segmentation sequence output by the hidden Markov model.

After obtaining the above four word segmentation sequences, the four word segmentation sequences can be input to the MINI and then may be trained with Wikipedia-based corpus, thereby obtaining a probability table for each word in four states, as well as a probability table of all state transition combinations between words.

In combination with the probability table of all state transition combinations between words, the probability of each word segmentation sequence can be obtained.

Sub-step N5: selecting one word segmentation sequence with the maximum probability from the multiple word segmentation sequences, for performing word segmentation processing on the painting brief introduction information, thereby obtaining multiple introduction-word segmentations.

Then, for each sentence, a Viterbi algorithm may be used to find the state sequence with the maximum probability path, and then the sentence is segmented according to this sequence.

It will be appreciated that the above two word segmentation modes are only two modes listed for better understanding of the technical solutions of the embodiments of the present disclosure. In specific implementation, other word segmentation modes may also be adopted, which may be determined according to service requirements and is not limited herein.

After performing word segmentation processing on the painting brief introduction information to obtain multiple introduction-word segmentations, step 204 is performed.

Step 204: inputting the multiple introduction-word segmentations to a preset theme generation model, and obtaining the painting theme words.

The preset theme generation model refers to a model for outputting corresponding theme words based on a segmented text. The preset theme generation model may be a document theme generation model such as Latent Dirichlet Allocation (LDA) or TextRank.

After obtaining multiple introduction-word segmentations, the multiple introduction-word segmentations may be input to the preset theme generation model, thereby obtaining the painting theme words. Taking LDA as an example, one specific process of obtaining the painting theme words is described hereinafter.

In a specific implementation of the present disclosure, the above step 204 may include:

Sub-step S1: determining the number of themes, a first hyperparameter and a second hyperparameter.

In one embodiment of the present disclosure, a proper number of themes, the first hyperparameter and the second hyperparameter may be selected in advance by a business person. Specifically, for the selected number of themes, specific values of the first hyperparameter and the second hyperparameter may be determined according to service requirements and are not limited herein.

For example, a proper number of themes is selected to be K, hyperparameter vectors are \vec{α} and \hat{λ} (the parameters herein will be used in the following formulas for calculations).

After determining the number of themes, the first hyperparameter and the second hyperparameter, sub-step S2 is performed.

Sub-step S2: according to the number of themes, randomly assigning a theme index to each introduction-word segmentation.

After obtaining the number of themes, each theme is corresponding to a theme index. After obtaining the theme index of each theme, a theme index may be randomly assigned to each introduction-word segmentation of the painting brief introduction information. For example, a theme index Z is randomly assigned to each introduction-word segmentation of the painting brief introduction information in a data table.

After randomly assigning a theme index to each introduction-word segmentation according to the number of themes, sub-step S3 is performed.

Sub-step S3: calculating a theme distribution probability of the painting brief introduction information based on the first hyperparameter.

After randomly assigning a theme index to each introduction-word segmentation, the theme distribution probability of the painting brief introduction information may be calculated based on the first hyperparameter through the following formula (1):

βₗ=Dirichlet(\vec{α}) (1)

In the above formula (1), \vec{α} is the first hyperparameter and βₗ is the theme distribution probability of the painting brief introduction information.

Sub-step S4: calculating a theme word distribution probability of each introduction-word segmentation based on the second hyperparameter.

After assigning a theme index to each introduction-word segmentation, in combination with the second hyperparameter, the theme word distribution probability corresponding to the theme index assigned to each introduction-word segmentation may be calculated through the following formula (2):

ηₖ=Dirichlet(\vec{λ}) (2)

In the above formula (2), \vec{λ} is the second hyperparameter, and ηₖ is the theme word distribution probability.

Sub-step S5: updating the theme index of each introduction-word segmentation with Gibbs sampling formula, and repeatedly performing the sub-step S3 and the sub-step S4.

Gibbs sampling is an algorithm used for Markov chain Monte Carlo (MCMC) in statistics, and is used to approximately extract sample sequences from a multivariate probability distribution when it is difficult to directly sample. This sequence may be used to approximate joint distribution, marginal distribution of some variables or to calculate integral (such as an expected value of a variable). Some variables may be known, and sampling is not required for these variables.

After the above sub-step S3 and sub-step S4, the theme index of each introduction-word segmentation may be updated with Gibbs sampling formula, i.e., re-assigning a theme index for each introduction-word segmentation, and the above sub-step S3 and sub-step S4 may be repeatedly performed, thereby calculating a theme distribution probability and a theme word distribution probability after the theme index of each introduction-word segmentation is updated.

Sub-step S6: when reaching convergence condition, calculating a synthetic index distribution probability for each theme index based on the calculated multiple theme distribution probabilities and multiple theme word distribution probabilities.

The convergence condition refers to a condition that the obtained theme distribution probability and theme word distribution probability hardly change after performing the above sub-step S5 for multiple times.

The synthetic index distribution probability refers to synthesis of a probability that each of the introduction-word segmentations belongs to a certain theme index. For example, introduction-word segmentations includes a word segmentation “a”, a word segmentation “b” and a word segmentation “c”, a probability that the word segmentation “a” belongs to a theme index A is 0.1, a probability that the word segmentation “b” belongs to the theme index A is 0.3, and a probability that the word segmentation “c” belongs to the theme index A is 0.8, then, in combination with these probabilities, the synthetic index distribution probability can be calculated through the following formula (3):

Zₙ=multi(βₗ) (3)

In the above formula (3), Zₙ represents a synthetic index distribution probability; βₗ represents a theme word distribution probability. That is to say, the synthetic index distribution probability can be calculated by multiplying the theme word distribution probabilities which are obtained through the above calculation.

Of course, in one embodiment of the present disclosure, the theme index distribution probability is not calculated for all theme indexes, instead, in combination with the theme distribution probability, the theme index distribution probability is calculated for the theme index corresponding to the theme distribution probability which is greater than a threshold, thereby eliminating error influence of the theme index with small probability on the calculation result.

Sub-step S7: calculating a synthetic word distribution probability of each of the theme words based on the synthetic index distribution probability of each of the theme indexes.

The synthetic word distribution probability refers to synthesis of a probability that each of the introduction-word segmentations belongs to a certain theme word.

After obtaining the synthetic index distribution probability corresponding to each theme index, in combination with the synthetic index distribution probability of each theme index, the synthetic word distribution probability of each of the theme words can be calculated through the following formula (4):

Wₙ=multi(Zₙ) (4)

In the above formula (4), Wn represents a synthetic word distribution probability. That is to say, the synthetic word distribution probability can be calculated by multiplying the synthetic index distribution probabilities which are obtained through the above calculation.

Sub-step S8: using the theme word corresponding to the maximum synthetic word distribution probability selected from the synthetic word distribution probabilities as the painting theme word.

After obtaining the synthetic word distribution probability of each theme word, the theme word corresponding to the maximum synthetic word distribution probability selected from the synthetic word distribution probabilities may be used as the painting theme word of the target painting.

In some examples, there may be one final painting theme word. For example, for multiple theme words including a theme word “A”, a theme word “B” and a theme word “C”, a synthetic word distribution probability of the theme word “A” is 0.8, a synthetic word distribution probability of the theme word “B” is 0.5, and a synthetic word distribution probability of the theme word “C” is 0.6, then, the theme word “A” is used as the painting theme word.

In some examples, there may be two or more final painting theme words. For example, for multiple theme words including a theme word “A”, a theme word “B”, a theme word “C”, and a theme word “D”, a synthetic word distribution probability of the theme word “A” is 0.8, a synthetic word distribution probability of the theme word “B” is 0.7, a synthetic word distribution probability of the theme word “C” is 0.6, a synthetic word distribution probability of the theme word “D” is 0.8, then, the theme word “A” and the theme word “D” are used as the painting theme words.

It will be appreciated that, the above steps take the LDA model as an example to train multiple introduction-word segmentations and output painting theme words; and other theme generation models may refer to the related art, which will not be elaborated herein.

After inputting the multiple introduction-word segmentations to the preset theme generation model and obtaining the painting theme words, step 205 is performed.

Step 205: performing clustering processing on the painting theme word to obtain a theme word category corresponding to the painting theme word.

Since there are many types of theme words in the painting content introduction, if each theme word is used individually as a label, it will seriously affect efficiency of query or recommendation, and it cannot reflect the correlation between words. Therefore, in one embodiment of the present disclosure, clustering processing may be performed on the painting theme words corresponding to the target painting, thereby obtaining the theme word category corresponding to the painting theme word.

The detailed process of performing clustering processing on the painting theme word is described hereinafter.

In a specific implementation of the present disclosure, the above step 205 may include:

Sub-step B1: performing word embedding-encoding processing on the painting theme word to generate a theme word vector corresponding to the painting theme word.

In one embodiment of the present disclosure, the theme word vector refers to a vector obtained by converting the painting theme word into vector form for representation.

The word embedding means that, after extracting the theme words in the painting brief introduction information, the extracted theme words are mapped into numerical vectors in order to further process the extracted theme words.

After obtaining the painting theme word, the word embedding-encoding process may be performed on the painting theme word, thereby generating the theme word vector corresponding to the theme word. For example, the painting theme word may be input into a word vector model, and then the word vector model can output a theme word vector corresponding to the painting theme word. Specifically, it will be described in detail in conjunction with the following specific implementation.

In another specific implementation of the present disclosure, the foregoing sub-step B1 may include:

Sub-step C1: inputting the painting theme word into a word vector model;

Sub-step C2: receiving the theme word vector output by the word vector model.

In one embodiment of the present disclosure, the Bert model may be used to perform word embedding-coding processing on the theme word. The Bert model is a word vector model with a basic integration unit of a transformer encoder, and has a large number of encoder layers. Meanwhile, the Bert model has a large feed-forward neural network (including 768-1024 hidden layer neurons) and 12-16 attention heads. In the Bert model, a fixed-length string is used as input, data is transmitted from bottom to top for calculation, each layer uses the self attention mechanism and transmits its result through the feed-forward neural network to a next encoder, and the output returned by the model is a vector of a size of the hidden layer (768-1024 dimensions).

It will be appreciated that, the above examples are only examples for better understanding of the technical solutions of the embodiments of the present disclosure, other methods may also be used to obtain the theme word vector corresponding to the painting theme word, which may be determined according to service requirements and is not limited herein.

After performing word embedding-encoding processing on the painting theme word to generate a theme word vector corresponding to the painting theme word, sub-step B2 is performed.

Sub-step B2: performing clustering processing on the painting theme word according to the theme word vector, to generate the theme word category.

After obtaining the theme word vector corresponding to the painting theme word, the clustering processing may be performed on the painting theme word according to the theme word vector, thereby obtaining the theme word category corresponding to each painting theme word. Specifically, it will be described in detail in conjunction with the following specific implementation.

In another specific implementation of the present disclosure, the foregoing sub-step B2 may include:

Sub-step D1: constructing an initial clustering feature tree according to the theme word vector;

Sub-step D2: determining a theme word category corresponding to the theme word vector based on the initial clustering feature tree and a maximum radius threshold.

In one embodiment of the present disclosure, a top-down method may be used to perform clustering processing on the painting theme words, so that painting theme words of the same category have high relevance, and painting theme words of different categories are as irrelevant as possible. The specific process is as follows:

(1) traversing all the theme word vectors to establish an initial clustering feature tree;

(2) each time one theme word vector is read in, selecting a leaf node to which the one theme word vector belongs according to the maximum radius threshold, or establishing a new leaf node;

(3) when the number of samples of one leaf node exceeds a threshold, splitting the one leaf node down into two new leaf nodes;

(4) when the number of leaf nodes of one root node exceeds a threshold, splitting the one root node down into two child nodes.

In the above process, each of the root node and the child node represents a category of theme words. The root node is a parent class and the child nodes are subclasses. One parent class may contain one or more subclasses, that is, all painting theme words are classified and one or more painting theme terms may be classified into one category.

It will be appreciated that, the above process are only examples for better understanding of the technical solutions of the embodiments of the present disclosure, other methods may also be used to determine the theme word category, which may be determined according to service requirements and is not limited herein.

After performing clustering processing on the painting theme word to obtain a theme word category corresponding to the painting theme word, step 206 is performed.

Step 206: generating the painting label based on the painting attribute information and the theme word category.

After obtaining the painting attribute information and theme word category corresponding to the target painting, the painting label of the target painting may be generated according to the painting attribute information and the theme word category corresponding to the painting theme word. For example, after performing the above processing on the painting information, a final painting label category system includes the following label types:

(1) painting name, painting author, nationality, creation place, creation medium (such as paper, cloth), genre, collection place, category (such as oil painting, sketch);

(2) painting creation period (range of years), size (type of length-width ratio), price (range);

(3) categories of theme words.

In one embodiment of the present disclosure, the painting label of the target painting is automatically generated according to the painting basic information and the painting brief introduction information, without manually adding the painting label.

In the painting label generation method according to one embodiment of the present disclosure, the painting basic information and the painting brief introduction information of the target painting is first obtained, and then the painting attribute information is generated by pre-processing the painting basic information; then, painting theme words are generated by extracting theme words from the painting brief introduction information and then a painting label is generated for the target painting according to the painting attribute information and the painting theme words. In this way, the painting label of the target painting is automatically generated according to the painting basic information and the painting brief introduction information, without manually adding the painting label, thereby ensuring consistency of painting labels, avoiding redundant label information, and reducing investment in human resources costs.

For the foregoing method embodiments, for the sake of simple description, they are all expressed as a series of action combinations, but those skilled in the art should know that the present disclosure is not limited by the sequence of actions described, because some steps may be performed in other orders or simultaneously. In addition, those skilled in the art should also know that the embodiments described in the specification are all optional embodiments, and the involved actions and modules are not necessarily required by the present disclosure.

In addition, one embodiment of the present disclosure further provides an electronic device, including: a processor, a memory, and a computer program stored on the memory and executable on the processor. The processor executes the program to implement the painting label generation method described above.

The various embodiments in the present specification are described in a progressive manner, and each embodiment focuses on differences from other embodiments, and the same similar parts between the various embodiments can be referred to each other.

It should also be noted that in this application, relational terms such as first and second are merely used to differentiate different components rather than to represent any order, number or importance. Further, the term “including”, “include” or any variants thereof is intended to cover a non-exclusive contain, so that a process, a method, an article or a user equipment, which includes a series of elements, includes not only those elements, but also includes other elements which are not explicitly listed, or elements inherent in such a process, method, article or user equipment. In absence of any further restrictions, an element defined by the phrase “including one . . . ” does not exclude the existence of additional identical elements in a process, method, article, or user equipment that includes the element.

The above are merely the preferred embodiments of the present disclosure. It should be noted that, a person skilled in the art may make improvements and modifications without departing from the principle of the present disclosure, and these improvements and modifications shall also fall within the scope of the present disclosure.

What is claimed is:

1. A painting label generation method, comprising:
obtaining painting basic information and painting brief introduction information of a target painting;
generating painting attribute information by pre-processing the painting basic information;
generating a painting theme word by extracting a theme word from the painting brief introduction information; and
generating a painting label for the target painting according to the painting attribute information and the painting theme word.

2. The method according to claim 1, wherein the generating a painting theme word by extracting a theme word from the painting brief introduction information, includes:
performing word segmentation processing on the painting brief introduction information to obtain a plurality of introduction-word segmentations;
inputting the plurality of introduction-word segmentations to a preset theme generation model, and obtaining the painting theme word.

3. The method according to claim 2, wherein the performing word segmentation processing on the painting brief introduction information to obtain a plurality of introduction-word segmentations, includes:
constructing a prefix dictionary based on a dictionary of a corpus, and counting occurrence frequencies of prefix words of the prefix dictionary in the dictionary of the corpus;
based on the prefix dictionary, obtaining a plurality of text segmentation modes for each sentence of information text in the painting brief introduction information;
determining a segmentation probability of each of the plurality of text segmentation modes in combination with each sentence of information text and each of the occurrence frequencies;
obtaining the text segmentation mode with a maximum segmentation probability among the plurality of text segmentation modes;
using the text segmentation mode with the maximum segmentation probability to perform word segmentation processing on the painting brief introduction information, thereby obtaining the plurality of introduction-word segmentations.

4. The method according to claim 2, wherein the performing word segmentation processing on the painting brief introduction information to obtain a plurality of introduction-word segmentations, includes:
constructing a hidden Markov model (HMM) based on to-be-segmented texts in the painting brief introduction information;
obtaining a plurality of word segmentation sequences corresponding to the to-be-segmented texts;
inputting the plurality of word segmentation sequences to the hidden Markov model;
receiving a probability of each of the plurality of word segmentation sequences output by the hidden Markov model;
selecting one word segmentation sequence with a maximum probability from the plurality of word segmentation sequences, for performing word segmentation processing on the painting brief introduction information, thereby obtaining the plurality of introduction-word segmentations.

5. The method according to claim 2, wherein the inputting the plurality of introduction-word segmentations to a preset theme generation model, and obtaining the painting theme word, includes:
determining the number of themes, a first hyperparameter and a second hyperparameter;
according to the number of themes, randomly assigning a theme index to each of the plurality of introduction-word segmentations;
calculating a theme distribution probability of the painting brief introduction information based on the first hyperparameter;
calculating a theme word distribution probability of each of the plurality of introduction-word segmentations based on the second hyperparameter;
updating the theme index of each of the plurality of introduction-word segmentations with Gibbs sampling formula, and repeatedly performing the step of calculating a theme distribution probability of the painting brief introduction information based on the first hyperparameter and the step of calculating a theme word distribution probability of each of the plurality of introduction-word segmentations based on the second hyperparameter;
when reaching convergence condition, calculating a synthetic index distribution probability for each theme index based on calculated theme distribution probabilities and theme word distribution probabilities;
calculating a synthetic word distribution probability of each theme word based on the synthetic index distribution probability of each theme index;
using the theme word corresponding to a maximum synthetic word distribution probability selected from the synthetic word distribution probability of each theme word as the painting theme word.

6. The method according to claim 1, wherein before the generating a painting label for the target painting according to the painting attribute information and the painting theme word, the method further includes: performing clustering processing on the painting theme word to obtain a theme word category corresponding to the painting theme word;
wherein the generating a painting label for the target painting according to the painting attribute information and the painting theme word, includes:
generating the painting label based on the painting attribute information and the theme word category.

7. The method according to claim 6, wherein the performing clustering processing on the painting theme word to obtain a theme word category corresponding to the painting theme word, includes:
performing word embedding-encoding processing on the painting theme word to generate a theme word vector corresponding to the painting theme word;
performing clustering processing on the painting theme word according to the theme word vector, to generate the theme word category.

8. The method according to claim 7, wherein the performing word embedding-encoding processing on the painting theme word to generate a theme word vector corresponding to the painting theme word, includes:
inputting the painting theme word into a word vector model;
receiving the theme word vector output by the word vector model.

9. The method according to claim 7, wherein the performing word embedding-encoding processing on the painting theme word to generate a theme word vector corresponding to the painting theme word, includes:
constructing an initial clustering feature tree according to the theme word vector;
determining the theme word category corresponding to the theme word vector based on the initial clustering feature tree and a maximum radius threshold.

10. The method according to claim 1, wherein the painting basic information includes at least one of author information, size information, creation year information and price information;
the generating painting attribute information by pre-processing the painting basic information, includes at least one of:
adjusting the author information according to a preset name format to generate a painting name attribute;
determining a size proportion attribute corresponding to the target painting according to the size information;
determining a year classification attribute corresponding to the target painting according to the creation year information;
determining a price classification attribute corresponding to the target painting according to the price information.

11. An electronic device, comprising: a processor, a memory, and a computer program stored on the memory and executable on the processor; wherein the processor executes the program to implement steps of:
obtaining painting basic information and painting brief introduction information of a target painting;
generating painting attribute information by pre-processing the painting basic information;
generating a painting theme word by extracting a theme word from the painting brief introduction information; and
generating a painting label for the target painting according to the painting attribute information and the painting theme word.

12. The electronic device according to claim 11, wherein when implementing the step of generating a painting theme word by extracting a theme word from the painting brief introduction information, the processor is further configured to,
generate a painting theme word by extracting a theme word from the painting brief introduction information, includes:
perform word segmentation processing on the painting brief introduction information to obtain a plurality of introduction-word segmentations;
input the plurality of introduction-word segmentations to a preset theme generation model, and obtain the painting theme word.

13. The electronic device according to claim 12, wherein when implementing the step of performing word segmentation processing on the painting brief introduction information to obtain a plurality of introduction-word segmentations, the processor is further configured to,
construct a prefix dictionary based on a dictionary of a corpus, and count occurrence frequencies of prefix words of the prefix dictionary in the dictionary of the corpus;
based on the prefix dictionary, obtain a plurality of text segmentation modes for each sentence of information text in the painting brief introduction information;
determine a segmentation probability of each of the plurality of text segmentation modes in combination with each sentence of information text and each of the occurrence frequencies;
obtain the text segmentation mode with a maximum segmentation probability among the plurality of text segmentation modes;
use the text segmentation mode with the maximum segmentation probability to perform word segmentation processing on the painting brief introduction information, thereby obtaining the plurality of introduction-word segmentations.

14. The electronic device according to claim 12, wherein when implementing the step of performing word segmentation processing on the painting brief introduction information to obtain a plurality of introduction-word segmentations, the processor is further configured to,
construct a hidden Markov model (HMM) based on to-be-segmented texts in the painting brief introduction information;
obtain a plurality of word segmentation sequences corresponding to the to-be-segmented texts;
input the plurality of word segmentation sequences to the hidden Markov model;
receive a probability of each of the plurality of word segmentation sequences output by the hidden Markov model;
select one word segmentation sequence with a maximum probability from the plurality of word segmentation sequences, for performing word segmentation processing on the painting brief introduction information, thereby obtaining the plurality of introduction-word segmentations.

15. The electronic device according to claim 12, wherein when implementing the step of inputting the plurality of introduction-word segmentations to a preset theme generation model, and obtaining the painting theme word, the processor is further configured to,
determine the number of themes, a first hyperparameter and a second hyperparameter;
according to the number of themes, randomly assign a theme index to each of the plurality of introduction-word segmentations;
calculate a theme distribution probability of the painting brief introduction information based on the first hyperparameter;
calculate a theme word distribution probability of each of the plurality of introduction-word segmentations based on the second hyperparameter;
update the theme index of each of the plurality of introduction-word segmentations with Gibbs sampling formula, and repeatedly perform the step of calculating a theme distribution probability of the painting brief introduction information based on the first hyperparameter and the step of calculating a theme word distribution probability of each of the plurality of introduction-word segmentations based on the second hyperparameter;
when reaching convergence condition, calculate a synthetic index distribution probability for each theme index based on calculated theme distribution probabilities and theme word distribution probabilities;
calculate a synthetic word distribution probability of each theme word based on the synthetic index distribution probability of each theme index;
use the theme word corresponding to a maximum synthetic word distribution probability selected from the synthetic word distribution probability of each theme word as the painting theme word.

16. The electronic device according to claim 11, wherein before implementing the step of generating a painting label for the target painting according to the painting attribute information and the painting theme word, the processor is further configured to perform clustering processing on the painting theme word to obtain a theme word category corresponding to the painting theme word;
when implementing the step of generating a painting label for the target painting according to the painting attribute information and the painting theme word, the processor is further configured to generate the painting label based on the painting attribute information and the theme word category.

17. The electronic device according to claim 16, wherein when implementing the step of performing clustering processing on the painting theme word to obtain a theme word category corresponding to the painting theme word, the processor is further configured to,
perform word embedding-encoding processing on the painting theme word to generate a theme word vector corresponding to the painting theme word;
perform clustering processing on the painting theme word according to the theme word vector, to generate the theme word category.

18. The electronic device according to claim 17, wherein when implementing the step of performing word embedding-encoding processing on the painting theme word to generate a theme word vector corresponding to the painting theme word, the processor is further configured to,
input the painting theme word into a word vector model;
receive the theme word vector output by the word vector model.

19. The electronic device according to claim 17, wherein when implementing the step of performing word embedding-encoding processing on the painting theme word to generate a theme word vector corresponding to the painting theme word, the processor is further configured to,
construct an initial clustering feature tree according to the theme word vector;
determine the theme word category corresponding to the theme word vector based on the initial clustering feature tree and a maximum radius threshold.

20. The electronic device according to claim 11, wherein the painting basic information includes at least one of author information, size information, creation year information and price information;
when implementing the step of generating painting attribute information by pre-processing the painting basic information, the processor is further configured to perform at least one of:
adjust the author information according to a preset name format to generate a painting name attribute;
determine a size proportion attribute corresponding to the target painting according to the size information;
determine a year classification attribute corresponding to the target painting according to the creation year information;
determine a price classification attribute corresponding to the target painting according to the price information.
